(19) United States
(12) Patent Application Publication
(10) Pub. No.: US 2007/0286974 A1
(43) Pub. Date: Dec. 13, 2007

(54) Sulfonated Fuel Tank

(75) Inventors: Scot Sholler, Canton, MI (US); Karim Amellal, Tecumseh (CA); Ryan Beebe, Clawson, MI (US)

Correspondence Address: HONIGMAN MILLER SCHWARTZ & COHN LLP, 38500 WOODWARD AVENUE, SUITE 100, BLOOMFIELD HILLS, MI, 48304-5048, US

(73) Assignee: Vitec, LLC, Detroit, MI (US)

(21) Appl. No.: 11/761,094

(22) Filed: Jun. 11, 2007

Related U.S. Application Data
(60) Provisional application No. 60/813,319, filed on Jun. 13, 2006.

(51) Int. Cl. B32B 27/08

(52) U.S. Cl. 428/35.7

(57) ABSTRACT

A device for retaining a fluid is disclosed. The device includes a fuel tank having a multi-layer structure including an inner layer having a first surface that defines a cavity of the fuel tank, an outer layer having a second surface that defines a contour of the fuel tank, and a gas that is exposed to one or more of the first and second surfaces to define a fuel permeation barrier of the fuel tank. The gas seeps into one or more of the first and second surfaces to define the fuel permeation barrier having a depth. A method is also disclosed.

### RELATED APPLICATION

This disclosure claims the benefit of Provisional Patent Application No. 60/813,319, filed on Jun. 13, 2006.

### FIELD OF THE INVENTION

The disclosure relates to fuel tanks and to sulfonated fuel tanks.

### DESCRIPTION OF THE RELATED ART

It is known in the art that vehicles may include a fuel tank that stores fuel. It is known in the art that fuel tanks may comprise plastic. Plastic fuel tanks, however, may have several drawbacks. One drawback may include, for example, the emission of hydrocarbons into the atmosphere. Accordingly, there is a need in the art to reduce or eliminate the emission of hydrocarbons from a plastic fuel tank that stores fuel.

### BRIEF DESCRIPTION OF THE DRAWINGS

The disclosure will now be described, by way of example, with reference to the accompanying drawings, in which:

FIG. 1 is a perspective view of a fuel tank in accordance with an exemplary embodiment of the invention

FIG. 2 is a partial cross-sectional view of the fuel tank according to line 2-2 of FIG. 1 in accordance with an exemplary embodiment of the invention;

FIG. 3 is another partial cross-sectional view of the fuel tank in accordance with an exemplary embodiment of the invention;

FIGS. 4A-4C each illustrate a method for sulfonating a fuel tank in accordance with an exemplary embodiment of the invention;

FIG. 5 is a partial cross-sectional electron microscope atomic scan image of the fuel tank according to FIG. 2 in accordance with an exemplary embodiment of the invention; and

FIG. 6 is an enlarged view of FIG. 3 according to line 6.

### DETAILED DESCRIPTION OF THE INVENTION

The Figures illustrate an exemplary embodiment of a sulfonated fuel tank in accordance with an embodiment of the invention. Based on the foregoing, it is to be generally understood that the nomenclature used herein is simply for convenience and the terms used to describe the invention should be given the broadest meaning by one of ordinary skill in the art.

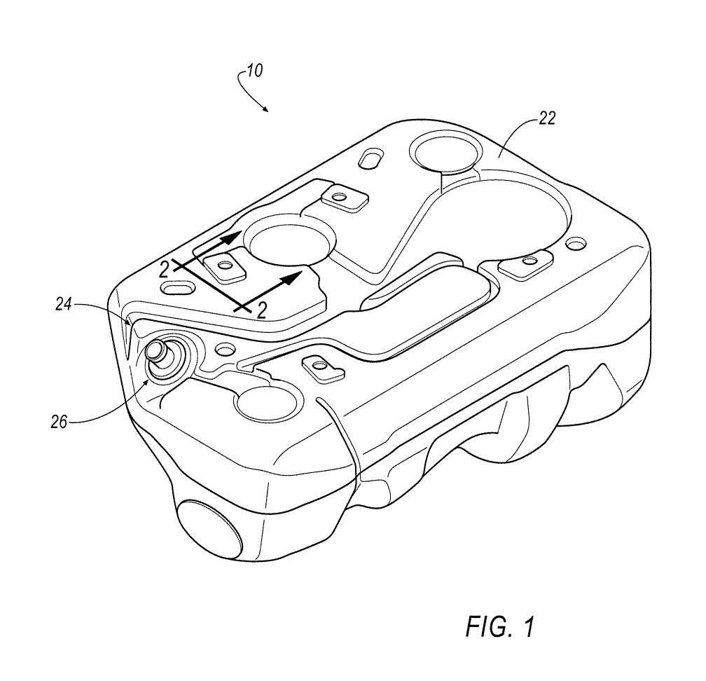

Referring to FIG. 1, a fuel tank is shown generally at 10 according to an embodiment. In an embodiment, the fuel tank 10 comprises plastic. The fuel tank 10 may include any desirable plastic material, such as, for example, high density polyethylene (HDPE). By utilizing plastic in the manufacture of the fuel tank 10, an overall weight reduction for a vehicle (not shown) may be achieved, which results in a more efficient operation of the vehicle.

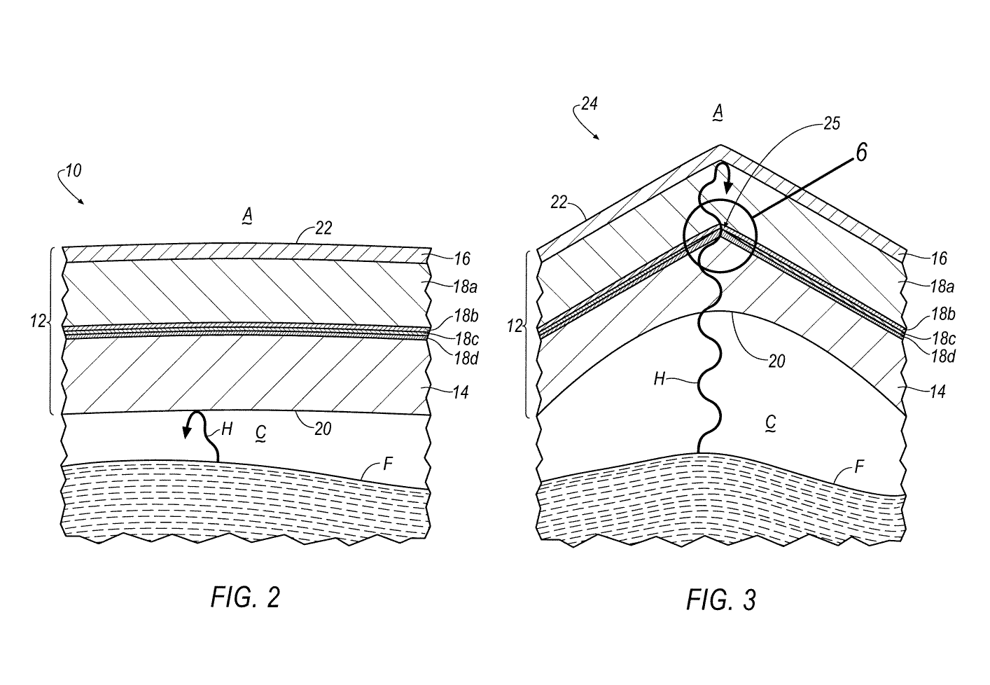

Referring to FIG. 2, the fuel tank 10 may be defined to include a multi-layer structure 12 that defines a fuel tank volume or cavity, C, relative to atmosphere, A. The multi-layer structure 12 is defined to include an inner layer 14, an outer layer 16, and, if desired, any amount of intermediate layers 18a-18d.

According to an embodiment, the inner layer 14 may comprise virgin HDPE. According to an embodiment, the virgin HDPE inner layer 14 may define approximately 40% (±10%) of the overall thickness of the multi-layer structure 12.

According to an embodiment, the outer layer 16 may comprise virgin HDPE. If desired, the outer layer 16 may also include a dye/colorant to provide any desirable pigmentation. If desired, the outer layer 16 may also include an additive for ultraviolet protection. According to an embodiment and without limitation, an exemplar dye/colorant with ultraviolet protection is commercially available and sold under the trade-name POLYBLACK®. According to an embodiment, the virgin HDPE outer layer 16 may define approximately 16% (±10%) of the overall thickness of the multi-layer structure 12.

According to an embodiment, the intermediate layer 18a may comprise recycled material. The recycled material of the intermediate layer 18a may be recovered from a grinder. Accordingly, the recycled material recovered from a grinder that comprises the intermediate layers 18a may be referred to hereinafter as regrind layer 18a. If desired, the regrind layer 18a may be melted and extruded, injected, or otherwise formed with the inner and outer layers 14, 16.

According to an embodiment, the regrind layer 18a may include recycled HDPE. In an embodiment, the regrind layer 18a may include a plurality or mixture of recycled materials. According to an embodiment and without limitation, the regrind layer 18a may include one or more of the materials identified in the multilayer structure 12 as discussed in this disclosure. According to an embodiment, the intermediate regrind layer 18a may define approximately 38% (±10%) of the overall thickness of the multi-layer structure 12. By including the regrind layer 18a, the overall cost of the fuel tank 10 may be reduced by utilizing recycled materials.

According to an embodiment, the intermediate layers 18b and 18d may comprise an adhesive. According to an embodiment, the intermediate adhesive layers 18b, 18d may include linear low density polyethylene (LLDPE). According to an embodiment, the LLDPE adhesive layers 18b, 18d may be co-extruded between approximately 200° C. and 230° C. through, for example, a spiral die.

Once the adhesive layers 18b, 18d have cooled, the LLDPE adhesive layers 18b, 18d thermally bond the HDPE inner layer 14, regrind layer 18a, and intermediate layer 18c. According to an embodiment and without limitation, an exemplar LLDPE adhesive layer 18b, 18d is sold under the trade-name ADMER®. According to an embodiment, the intermediate adhesive layers 18b, 18d may each define approximately 3% (±2%) of the overall thickness of the multi-layer structure 12.

According to an embodiment, the intermediate layer 18c, which is shown disposed between the adhesive layers 18b, 18d, may comprise a barrier layer of ethylene vinyl alcohol polymer (EVOH). The EVOH barrier layer 18c limits fuel emissions and functions as an internal hydrocarbon barrier layer. According to an embodiment, the intermediate EVOH barrier layer 18c may define approximately 3% (±2%) of the overall thickness of the multi-layer structure 12. Although the illustrated embodiment shown at FIG. 2 includes the regrind layer 18a, intermediate EVOH layer 18c and adhesive layers 18b, 18d, it will be appreciated that the fuel tank 10 is not limited or required to include the layers 18a-18d and that the fuel tank 10 may include the inner and outer layers 14, 16.

According to an embodiment, a surface 20 of the inner layer 14 generally defines an inner surface/geometry (i.e. the cavity, C) of the fuel tank 10 for storing a fluid, F, such as, for example, fuel (e.g. gasoline). According to an embodiment, a surface 22 of the outer layer 16 generally defines the outer surface/geometry of the fuel tank 10 that is exposed to atmosphere, A.

Referring to FIG. 3, the one or more layers 14-18d of the multi-layer structure 12 may be defined to include several pinched portions 24, which may be referred to in the art as “pinch areas.” Pinch portions 24 may be found about the surfaces 20, 22 as a result of a forming/molding operation or the like. The cross-section of a pinched portion 24 may be defined by an irregularity in the contour or thickness of the fuel tank 10 as compared to a portion of the multi-layer structure 12 that does not include a pinched portion 24 (i.e., as shown in FIG. 2). In addition, as described in greater detail below, the cross-section of the fuel tank 10, as defined by pinched portions 24, may also further define a reduced thickness or absence of any one of the intermediate layers 18a-18d, such as, for example, the EVOH barrier layer 18c (see, e.g., FIG. 6).

Referring to FIG. 1, the fuel tank 10 may also include one or more components 26. The one or more components 26 may be formed integrally with the multi-layer structure 12, or, alternatively, be connected to the fuel tank 10 by way of any desirable fastening methodology, such as, for example, welding. If formed integrally or connected to the fuel tank 10, the one or more components 26 may be defined by a multi-layer structure substantially similar to the multi-layer structure 12 of the fuel tank 10. Functionally, the one or more components 26 may include, for example, a connector, nozzle, or the like that provides fluid communication with, for example, a valve, pump, or the like (not shown).

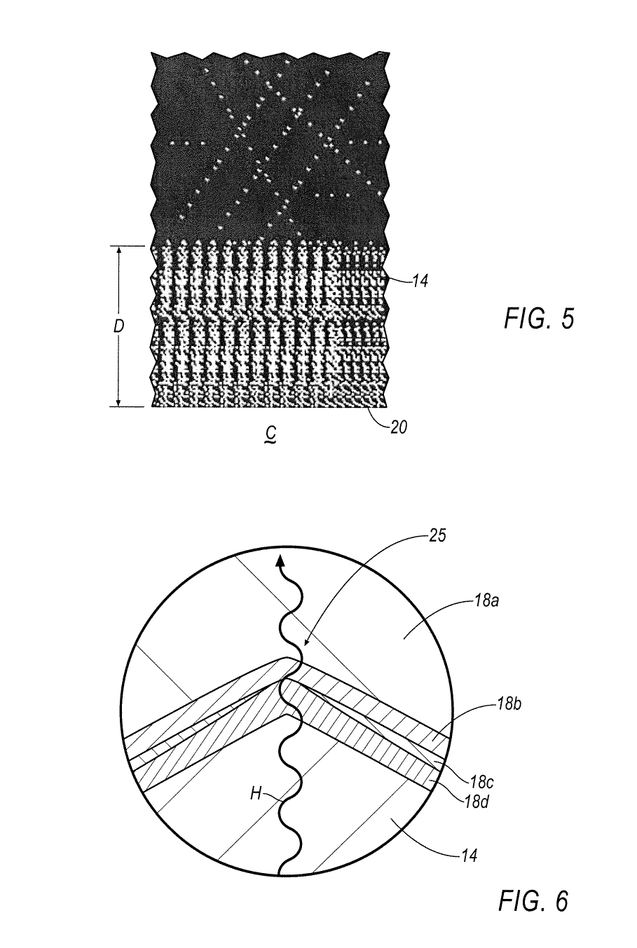

According to an embodiment, one or more of the layers 14-18d of the multi-layer structure 12, which may include, for example, the one or more components 26, may be defined to include a fuel permeation barrier (see, e.g., FIG. 5) that prevents the fluid, F, in the cavity, C, as well as vapors (e.g. hydrocarbon vapors, H) associated with the fluid, F, in the cavity, C, from escaping from the fuel tank 10 and into atmosphere, A. According to an embodiment, the fuel permeation barrier improves the fluid barrier properties of the fuel tank 10.

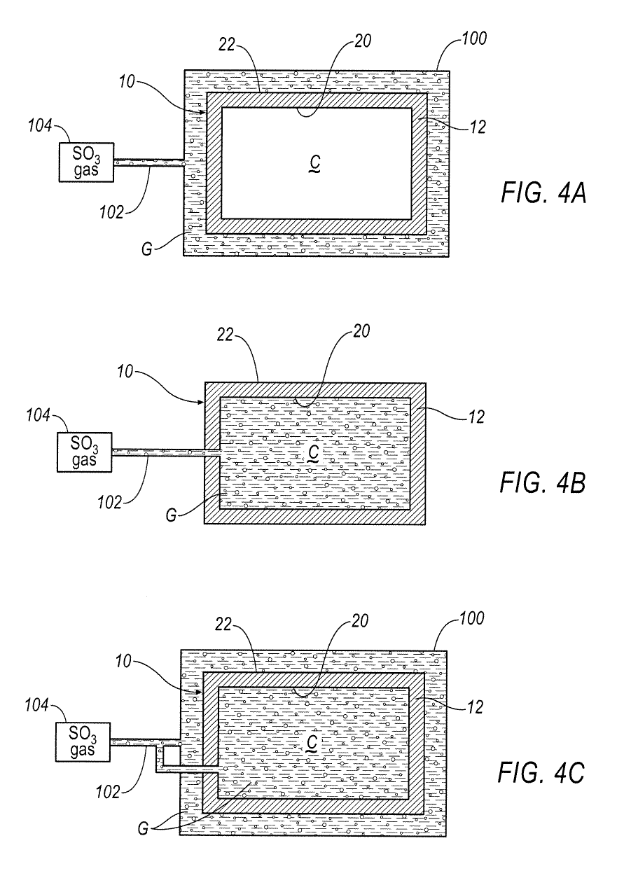

Referring to FIGS. 4A-4C, according to an embodiment, the fuel permeation barrier is provided by sulfonating the fuel tank 10 with a gas, G. According to an embodiment, the gas, G, may include sulfur trioxide (SO₃).

According to an embodiment, a portion, some, or all of the layers 14-18d of the multi-layer structure 12 of the fuel tank 10 is sulfonated by exposing at least a portion of the fuel tank 10 to the SO₃ gas, G. According to an embodiment, depending on the geometry, structure, and configuration of the fuel tank 10, the multi-layer structure 12 may be sulfonated for approximately 90-minutes to achieve a desired permeation of the gas, G, into the multi-layer structure 12.

Referring to FIG. 4A, the fuel tank 10 may be placed in an enclosed chamber 100 that is in fluid communication with a supply 104 of SO₃ gas, G, by way of a conduit 102. Prior to being placed in the chamber 100, the fuel tank 10 may be sealed such that SO₃ gas, G, may not enter the cavity, C. Thus, according to an embodiment, the surface 22 of HDPE outer layer 16 of the fuel tank 10 may be sulfonated with the SO₃ gas, G, while the fuel tank 10 is placed in the chamber 100.

Alternatively, referring to FIG. 4B, the cavity, C, of the fuel tank 10 may be in fluid communication with the supply 104 of SO₃ gas, G, by way of the conduit 102. The cavity, C, may be sealed such that the exposure of the SO₃ gas, G, to the fuel tank 10 is limited to the surface 20 of HDPE inner layer 14.

Alternatively, referring to FIG. 4C, the fuel tank 10 may be placed in the chamber 100 such that SO₃ gas, G, is provided from the supply 104 for exposure to both of the surfaces 20, 22 of the fuel tank 10 as shown and described in FIGS. 4A and 4B. Accordingly, both the inner and outer HDPE layers 14, 16 may be sulfonated with the SO₃ gas, G. Although the fuel tank 10 is shown having both of its surfaces 20, 22 being sulfonated simultaneously, it will be appreciated that the surfaces 20, 22 may be sulfonated individually as shown and described in FIGS. 4A and 4B.

Referring to FIG. 5, a cross-sectional electron microscope atomic scan image of a permeation barrier is shown according to an embodiment. According to an embodiment, the HDPE inner layer 14 is illustrated as a layer of the multi-layer structure 12 that is sulfonated with the SO₃ gas, G (i.e., as shown in FIG. 4B). However, the scanned image of FIG. 5 is not limited to the HDPE inner layer 14, and, as such, it will be appreciated that other layers, such as, for example, the HDPE outer layer 16 may be sulfonated with the SO₃ gas, G (i.e., as shown in FIG. 4A), and define a substantially similar image as that shown in FIG. 5 as related to the HDPE inner layer 14.

According to an embodiment, the SO₃ gas, G, may be quantified by seeping into the HDPE inner and/or outer layer(s) 14, 16 through the surface(s) 20, 22 to a depth, D. The depth, D, generally defines the fuel permeation barrier that prevents, for example, hydrocarbons, H, associated with fuel, F, stored in the cavity, C, from escaping into atmosphere, A. The depth, D, may range between approximately, for example, 25-50 microns. Although the SO₃ gas, G, is described to permeate the inner and outer layers 14, 16, at a depth, D, it will be appreciated that the thickness of the layers 14-18d may be increased or decreased to limit or otherwise promote the permeation of the SO₃ gas, G, to one of, some, or all of the layers 14-18d of the fuel tank 10.

Referring back to FIGS. 2 and 3, it will be appreciated that although the inner and/or outer layer(s) 14, 16 are sulfonated with the SO₃ gas, the EVOH barrier layer 18c may also function in a substantially similar manner as the sulfonated HDPE inner and/or outer layer(s) 14, 16 by preventing hydrocarbons, H, stored in the cavity, C, from escaping into atmosphere, A. As such, referring to FIG. 2, if, for example, escaping hydrocarbons, H, are not blocked or prevented by the inner layer 14 from escaping to atmosphere, A, one or more of the EVOH barrier layer 18c and sulfonated outer later 16 may serve to supplement the hydrocarbon-blocking properties of the inner layer 14.

Referring to FIGS. 3 and 6, when the fuel tank 10 is formed to include pinched portions 24, a pinched zone 25 may define a reduced thickness, or, alternatively, an absence of the thickness of the EVOH barrier layer 18c. According to an embodiment, if, for example, the pinched zone 25 includes a reduced thickness/absence of the EVOH barrier layer 18c, and, if for example, the HDPE inner layer 14 is not sulfonated as described in FIG. 2, hydrocarbons, H, that may otherwise escape toward atmosphere, A, through the HDPE inner layer 14 and pinched zone 25 may be otherwise prevented from escaping into atmosphere, A, by the outer layer 16, as shown in FIG. 3. Thus, the sulfonating of the outer layer 16 may serve to supplement the hydrocarbon-blocking properties of one or more of the inner layer 14 and/or the barrier layer 18c.

The present invention has been described with reference to certain exemplary embodiments thereof. However, it will be readily apparent to those skilled in the art that it is possible to embody the invention in specific forms other than those of the exemplary embodiments described above. This may be done without departing from the spirit of the invention. The exemplary embodiments are merely illustrative and should not be considered restrictive in any way. The scope of the invention is defined by the appended claims and their equivalents, rather than by the preceding description.

What is claimed is:

1. A device for retaining a fluid, comprising:
a fuel tank having a multi-layer structure including,
an inner layer having a first surface that defines a cavity of the fuel tank;
an outer layer having a second surface that defines a contour of the fuel tank; and
a fuel permeation barrier formed on at least one of said first and second surfaces of the fuel tank, and wherein the fuel permeation barrier extends into at least one of said inner layer or said outer layer to define the fuel permeation barrier having a depth.

2. The device according to claim 1, wherein the fuel permeation barrier includes sulfur trioxide.

3. The device according to claim 1, wherein the depth is approximately between 25-50 microns.

4. The device according to claim 1, wherein the inner layer and the outer layer include virgin high density polyethylene.

5. The device according to claim 4, wherein the outer layer includes an ultraviolet protection additive.

6. The device according to claim 1, further comprising:
a layer of regrind high density polyethylene disposed between the inner and outer layers.

7. The device according to claim 1, further comprising:
a layer of ethylene vinyl alcohol polymer disposed between the inner and outer layers.

8. The device according to claim 7, further comprising:
a first layer of linear low density polyethylene adhesive disposed between the inner layer and the layer of ethylene vinyl alcohol polymer, and
a second layer of linear low density polyethylene adhesive disposed between the outer layer and the layer of ethylene vinyl alcohol polymer.

9. The device according to claim 8, further comprising:
a layer of regrind high density polyethylene disposed between the second layer of linear low density polyethylene adhesive and the outer layer.

10. The device according to claim 7, wherein the multi-layer structure includes a pinched portion.

11. The device according to claim 10, wherein the pinched portion further includes a reduced thickness of the ethylene vinyl alcohol polymer layer.

12. The device according to claim 10, wherein the pinched portion further includes an absence of the thickness of the ethylene vinyl alcohol polymer layer.

13. The device according to claim 1, wherein the fuel tank further includes a component, wherein the component includes the multi-layer structure.

14. The device according to claim 13, wherein the component is integrally-formed with the fuel tank.

15. The device according to claim 13, wherein the component is welded to the fuel tank.

16. A method for manufacturing a device that retains a fluid, comprising the steps of:
forming a fuel tank to include a multi-layer structure, wherein the multi-layer structure includes,
an inner layer having a first surface that defines a cavity, and
an outer layer having a second surface that defines a contour; then
sulfonating at least one of the first and second surfaces with a gas including sulfur thereby forming a fuel permeation barrier.

17. The method according to claim 16, wherein the sulfonating step further includes exposing the gas to at least one of the first and second surfaces such that the gas migrates into at least one of the inner and outer layer through at least one of the first and second surfaces to define the fuel permeation barrier having a depth.

18. The method according to claim 17, wherein the gas includes sulfur trioxide (SO₃).

19. The method according to claim 17, wherein the depth is approximately between 25-50 microns.

20. A device for retaining a fluid, comprising:
a fuel tank having a multi-layer structure including
an inner layer having a first surface that defines a cavity of the fuel tank;
an outer layer having a second surface that defines a contour of the fuel tank that is exposed to atmosphere; and
means, combined with at least one of said inner and outer layers, for preventing hydrocarbon vapors from escaping the cavity.

21. The device according to claim 20, wherein the inner layer and the outer layer include virgin high density polyethylene.

22. The device according to claim 21, wherein the outer layer includes an ultraviolet protection additive.

23. The device according to claim 20, further comprising:
a layer of regrind high density polyethylene disposed between the inner and outer layers.

24. The device according to claim 20, further comprising:
a layer of ethylene vinyl alcohol polymer disposed between the inner and outer layers.

25. The device according to claim 24, further comprising:
a first layer of linear low density polyethylene adhesive disposed between the inner layer and the layer of ethylene vinyl alcohol polymer, and
a second layer of linear low density polyethylene adhesive disposed between the outer layer and the layer of ethylene vinyl alcohol polymer.

26. The device according to claim 25, further comprising:
a layer of regrind high density polyethylene disposed between the second layer of linear low density polyethylene adhesive and the outer layer.

27. The device according to claim 24, wherein the multi-layer structure defines a pinched portion.

28. The device according to claim 27, wherein the pinched portion further defines a reduced thickness of the ethylene vinyl alcohol polymer layer.

29. The device according to claim 27, wherein the pinched portion further defines an absence of the thickness of the ethylene vinyl alcohol polymer layer.

30. The device according to claim 20, wherein the fuel tank further includes a component, wherein the component includes the multi-layer structure.

31. The device according to claim 30, wherein the component is integrally-formed with the fuel tank.

32. The device according to claim 30, wherein the component is welded to the fuel tank.
